(19) United States
(12) Patent Application Publication
(10) Pub. No.: US 2006/0256514 A1
(43) Pub. Date: Nov. 16, 2006

(54) Pressure resistance cover for the display panel of a portable computer

(76) Inventor: Chin-Chang Wang, Taipei (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 11/214,925

(22) Filed: Aug. 31, 2005

(30) Foreign Application Priority Data
May 12, 2005 (TW) 094207662

(51) Int. Cl. G06F 1/16; B65D 85/38

(52) U.S. Cl. 361/683; 206/305; 206/320; 312/204; 312/223.1

(57) ABSTRACT

A pressure resistance cover for the display panel of a portable computer includes a rectangular frame defined by a first pair of corresponding sides and a second pair of corresponding sides; a first pair of sidewalls perpendicular to the first pair of sides; a second pair of sidewalls perpendicular to the second pair of sides and arranged in the same direction of the first pair of sidewalls; a first pair of pads attached to the inner sides of the first pair of sidewalls; a second pair of pads attached to the inner sides of the second pair of sidewalls; a top cover being a continuous surface coupled to the first and second pairs of sides; the continuous surface of the top cover is protruded from a direction opposite to the first and second pairs of sidewalls to form a pressure resistance structure for protecting the display panel.

### FIELD OF THE INVENTION

The present invention generally relates to a pressure resistance cover for the display panel of a portable computer, and more specifically relates to a pressure resistance cover for the display panel which is integrally formed into an arc or a circular roof shaped structure of a pressure resistance cover by injection molding and capable of diversifying and transmitting the stress applied onto the pressure resistance cover to four sides/vertices of the display panel so as to enhance the strength of the pressure resistance cover to prevent any possible damage to the display panel caused by a direct force exerted on the backside of the display and achieve the effect of protecting the display panel.

### BACKGROUND OF THE INVENTION

In recent years, the electronic and information industries are blooming, and related products becomes more precise days after day. As to the area of personal computers, a thin, lightweight, short and compact portable computer is the trend of personal computers, in addition to introducing computing units with faster and more powerful computing functions as well various peripherals to satisfy user requirements.

Since a portable computer emphasizes on its portability, therefore the portable computer may be damaged easily by collisions caused by external objects while the portable computer is carried or used. The flat display module may be cracked or damaged by accident due to excessive pressure created by users.

However, only present military computers or special-purpose industrial computers come with a design that can bear stronger impacts. In general, a portable computer usually cannot provide additional space for installing buffers, since portable computer emphasize on small volume and light weight.

Referring to FIG. 1 for a prior art disclosed in R.O.C. application Pat. No. 90212717 entitled “Portable computer and its buffer” filed on Sep. 26, 2001, a buffer 135 is coupled onto an edge/corner position 121 of an external casing of a display 12; a buffer 136 is coupled to an edge/corner position 122 of an external casing of the display 12; a buffer 131 is coupled onto an edge/corner position 111 of an external casing of the display 12; a buffer 132 is coupled onto an edge/corner position 112 of an external casing of the display 12; a buffer 133 is coupled onto an edge/corner position 113 of an external casing of the display 12; and a buffer 134 is coupled onto an edge/corner position 114 of an external casing of the display 12, such that the buffers 131, 132, 133, 134, 135. 136 can provide a buffer function for the portable computer when the portable computer is collided, so as to protect the display 12 and its internal components from being damaged or cracked by the collision. However, the technology as disclosed above only provides protections against the pressure coming from the edges or corners, but it cannot protect the display from the pressure exerted directly on the backside of the display which may cause damages to the display.

In a prior art disclosed in the R.O.C. Pat. No. 90204109 entitled “Enhanced frame structure for flat display panels” filed on Dec. 4, 2000, the components of a liquid crystal display device are fixed around the periphery of a liquid crystal display module by installing a metal frame sideway. It is also common to add wedge-type sheet metals onto the metal frame so as to enhance the stiffness of the structure.

Referring to FIG. 2, a cross-sectional view of a display unit of conventional notebook computer is illustrated. Since most notebook computers use a wedge-type light guide plate 202, a component such as a printed circuit board 203 is installed on the thin side of the light guide plate 202. A metal frame installed around the periphery of a whole LCD module of a thin film transistor (TFT) flat display 201 has substantial influence to the structural strength of the LCD module. Therefore, if the curvature and vibration of an LCD module are tested according to the reliability test requirements, the structural strength of the metal frame will be a key factor to the overall result of such test. However, the thickness of the metal frame is getting thinner to cope with the lightweight requirement, which will reduce the structural strength of the metal frame and adversely affect protection of the LCD panel.

Referring to FIG. 3 for the prior art disclosed in R.O.C. Pat. No. 90204109, the enhanced frame 3 of a flat panel display uses a curved cross-sectional design of installing at least one sidewall 32 on the frame to improve the structural strength and protect the internal components of the flat panel display module, but such technology cannot overcome the pressure coming from the backside of the display which may cause damages to the display.

### SUMMARY OF THE INVENTION

Therefore, it is a primary objective of the present invention to provide a pressure resistance cover for the display panel of a portable computer, and more specifically a pressure resistance cover for the display panel which is integrally formed into an arc or a circular roof shaped structure of a pressure resistance cover by injection molding and capable of diversifying and transmitting the stress applied onto the pressure resistance cover to four sides/vertices of the display panel so as to enhance the strength of the pressure resistance cover to prevent any possible damage to the display panel caused by a direct force exerted on the backside of the display and achieve the effect of protecting the display panel.

### BRIEF DESCRIPTION OF THE DRAWINGS

FIG. 1 is a view of a prior art portable computer and its buffer device;

FIG. 2 is a cross-sectional view of a prior art display unit of a notebook computer;

FIG. 3 is a view of an enhanced frame of a prior art flat display;

FIG. 4 is a perspective view of the structure in accordance with a preferred embodiment of the present invention;

FIG. 5 is a schematic view of the structure in accordance with another preferred embodiment of the present invention;

FIG. 6 is a cross-sectional view of the structure in accordance with a preferred embodiment of the present invention; and

FIG. 7 is a bottom view of the structure in accordance with a preferred embodiment of the present invention.

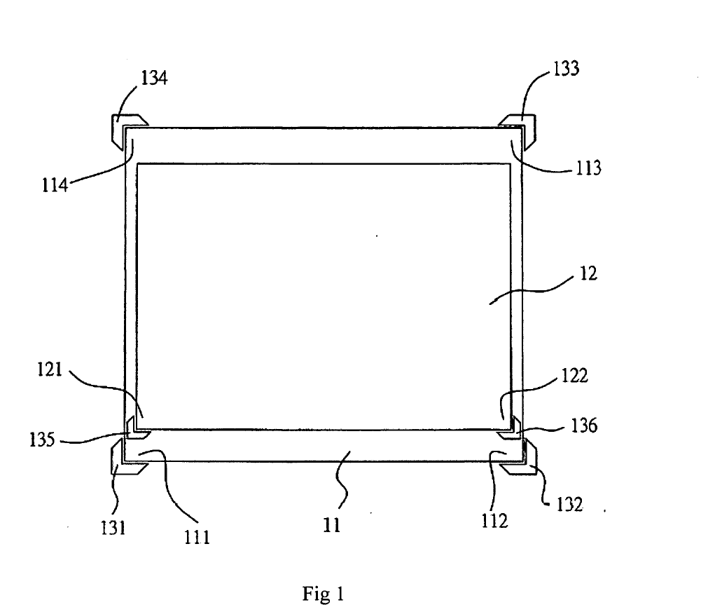

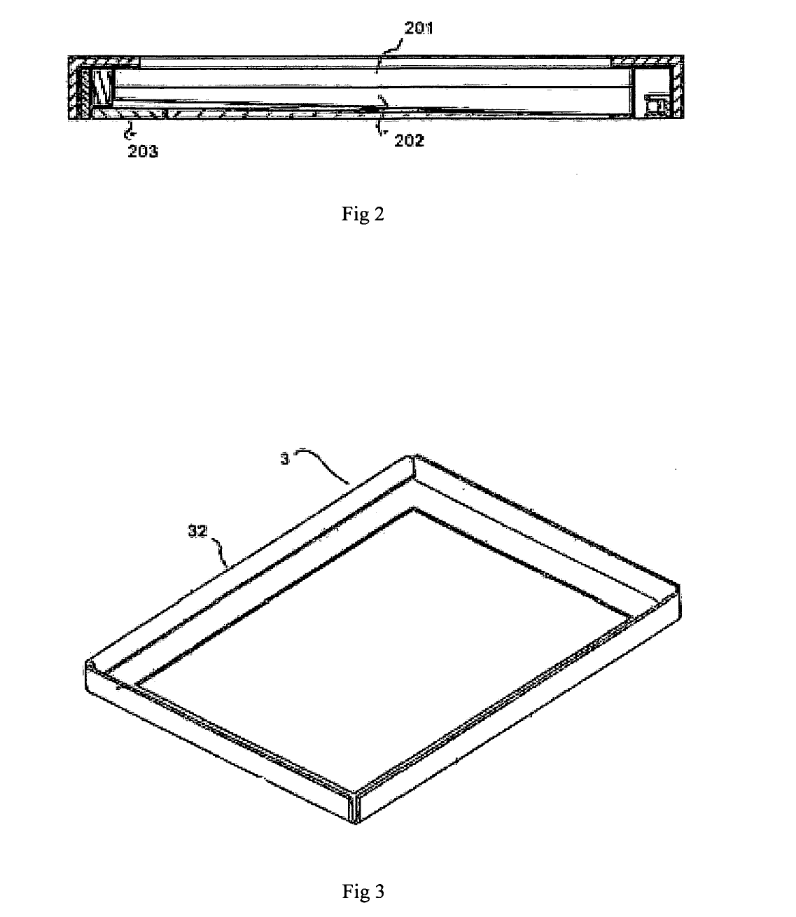

### DETAILED DESCRIPTION OF THE PREFERRED EMBODIMENTS

The above and other objects, features and advantages of the present invention will become apparent from the following detailed description of two preferred embodiments taken with the accompanying drawings.

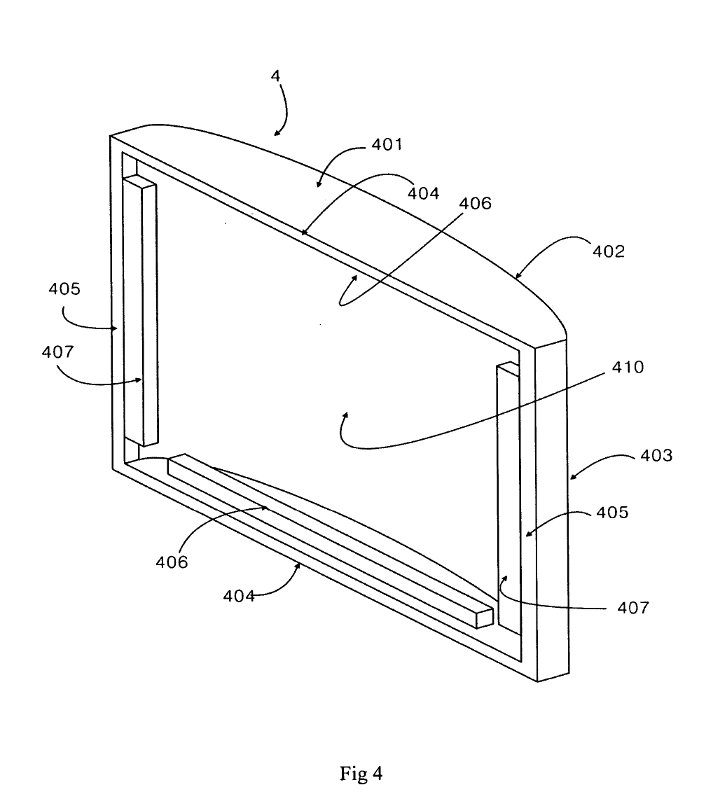

Referring to FIG. 4 for the perspective view of a pressure resistance cover for the display panel of a portable computer in accordance with a preferred embodiment of the present invention, the pressure resistance cover comprises a rectangular frame 401, defined by a first pair of corresponding sides 402 and a second pair of corresponding sides 403; a first pair of sidewalls 404, each being perpendicular to the first pair of sides 402; a second pair of sidewalls 405, each being perpendicular to the second pair of sides 403 and arranged in the same direction of the first pair of sidewalls 404; a first pair of pads 406 attached to the inner sides of the first pair of sidewalls 404; a second pair of pads 407 attached to the inner sides of the second pair of sidewalls 405; and a third pad 411 attached to the inner side of a top cover 410. The foregoing pads 406, 407, 411 are used to enhance the protection for the display module 602 and prevent possible damages to the display module 602 caused by vibrations. A top cover 410 is a continuous surface connected to each of the first corresponding pair of sides 402 and second corresponding pair of sides 403, and the continuous surface of the top cover 410 is protruded from a direction opposite to the first pair of sidewalls 404 and the second pair of sidewalls 403 to form a pressure resistance structure which has an arc shape and is integrally formed by mold injection. Such design can diversify and transmit the stress applied onto the pressure resistance cover to four sides/vertices of the display panel so as to enhance the strength of the pressure resistance cover to prevent any possible damage to the display panel caused by a direct force 601 exerted on the backside of the display module 602 and achieve the effect of protecting the display panel.

The present design can be applied for diversifying the stress of the pressure resistance cover onto the four sides/vertices so as to improve the pressure resistance of the rear cover and prevent any damage to the display module 602 caused by the pressure 601 directly exerted on the backside of the display, and achieve the effect of protecting the display panel.

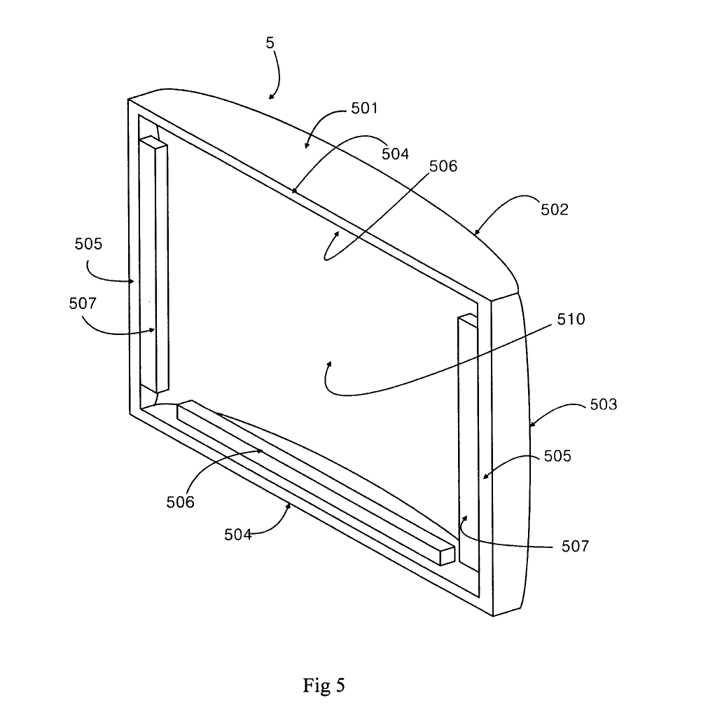

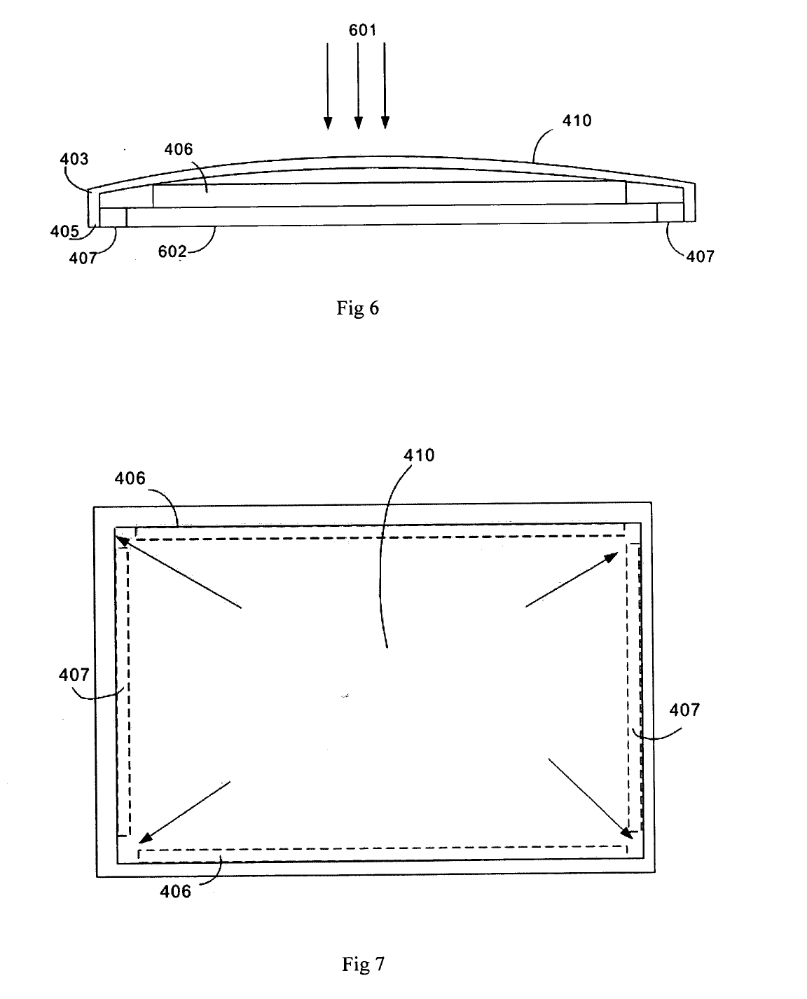

Referring to FIG. 5 for a perspective view of a pressure resistance cover for the display panel of a portable computer according to another preferred embodiment of the present invention, the pressure resistance cover comprises:

a rectangular frame 501, defined by a first pair of corresponding sides 502 and a second pair of corresponding sides 503;

a first pair of sidewalls 504, extended substantially perpendicular to the first pair of sides 502; a second pair of sidewalls 505 perpendicular to the second pair of sides 503 and arranged in the same direction of the first pair of sidewalls 504; a first pair of pads 506 attached onto an inner side of the first pair of sidewalls 504; a second pair of pads 507 attached onto an inner side of the second pair of sidewalls 505; and a third pad 511 attached onto an inner side of the top cover 510, and the foregoing pads are used for enhancing the protection of the display module 602 and preventing the display module from being damaged by vibrations; and

a top cover 510, being a continuous surface connected to each of the first corresponding pair of sides 502 and the second corresponding pair of sides 503, and the continuous surface of the top cover 510 is a stress diversifying structure protruded in an opposite direction from the first pair of sidewalls 504 and the second pairs of sidewalls 505 and is in a circular roof shape and integrally formed by a mold injection.

This design can be applied for diversifying and transmitting the stress on the pressure resistance cover to the four sides and vertices surrounding the display panel, so as to protect the pressure resistance cover and prevent possible damages to the display 602 caused by exerting pressure 601 on the backside of the display 602 and achieve the effect of protecting the display panel.

While the invention has been described by way of example and in terms of a preferred embodiment, it is to be understood that the invention is not limited thereto. To the contrary, it is intended to cover various modifications and similar arrangements and procedures, and the scope of the appended claims therefore should be accorded the broadest interpretation so as to encompass all such modifications and similar arrangements and procedures.

What is claimed is:

1. A pressure resistance cover for the display panel of a portable computer, comprising:
a rectangular frame, defined by a first pair of corresponding sides and a second pair of corresponding sides; and
a top cover, being a continuous surface connected to each of said first corresponding pair of sides and said second corresponding pair of sides, characterized in that:
said continuous surface of said top cover is a stress diversifying structure protruded progressively from at least one pair of sides to the center of said top cover.

2. The pressure resistance cover for the display panel of a portable computer of claim 1, wherein said top cover is a pressure diversifying structure with an arc shape or a circular roof shape.

3. The pressure resistance cover for the display panel of a portable computer of claim 1, further comprising:
a first pair of sidewalls, being extended in the an opposite direction of said first pair of two corresponding pairs of sides being protruded towards said top cover; and
a second pair of sidewalls, being extended in the an opposite direction of said second pair of two corresponding pairs of sides being protruded towards said top cover.

4. The pressure resistance cover for the display panel of a portable computer of claim 3, further comprising:
a first pair of pads, being attached onto an inner side of said first pair of sidewalls;
a second pair of pads, being attached onto an inner side of said second pair of sidewalls; and
a third pad, being attached onto an inner side of said top cover.

5. The pressure resistance cover for the display panel of a portable computer of claim 2, further comprising:
a first pair of sidewalls, being extended in the an opposite direction of said first pair of two corresponding pairs of sides being protruded towards said top cover; and
a second pair of sidewalls, being extended in the an opposite direction of said second pair of two corresponding pairs of sides being protruded towards said top cover.

6. The pressure resistance cover for the display panel of a portable computer of claim 5, further comprising:
a first pair of pads, being attached onto an inner side of said first pair of sidewalls;
a second pair of pads, being attached onto an inner side of said second pair of sidewalls; and
a third pad, being attached onto an inner side of said top cover.

7. The pressure resistance cover for the display panel of a portable computer of claims 1 or 2, wherein said rectangular frame and said top cover are integrally formed by a mold injection.

8. The pressure resistance cover for the display panel of a portable computer of claims 3, 4, 5 or 6, wherein said rectangular frame, said first pair of sidewalls, said second pair of sidewalls and said top cover are integrally formed by a mold injection.

9. A portable computer, comprising:
a main system;
a display, including a front panel and a rear panel for holding a display panel model;
a pivot, for connecting said main system and said display;
wherein said rear panel comprising:
a rectangular frame, defined by a first pair of corresponding sides and a second pair of corresponding sides; and
a top cover, being a continuous surface connected to each of said first corresponding pair of sides and said second corresponding pair of sides, characterized in that said continuous surface of said top cover is a stress diversifying structure protruded progressively from at least one pair of sides to the center of said top cover.

10. The portable computer of claim 9, wherein said top cover is a pressure diversifying structure with an arc shape or a circular roof shape.

11. The portable computer of claim 9, further comprising:
a first pair of sidewalls, being extended in the an opposite direction of said first pair of two corresponding pairs of sides being protruded towards said top cover; and
a second pair of sidewalls, being extended in the an opposite direction of said second pair of two corresponding pairs of sides being protruded towards said top cover.

12. The portable computer of claim 11, further comprising:
a first pair of pads, being attached onto an inner side of said first pair of sidewalls;
a second pair of pads, being attached onto an inner side of said second pair of sidewalls; and
a third pad, being attached onto an inner side of said top cover.

13. The portable computer of claim 10, further comprising:
a first pair of sidewalls, being extended in the an opposite direction of said first pair of two corresponding pairs of sides being protruded towards said top cover; and
a second pair of sidewalls, being extended in the an opposite direction of said second pair of two corresponding pairs of sides being protruded towards said top cover.

14. The portable computer of claim 13, further comprising:
a first pair of pads, being attached onto an inner side of said first pair of sidewalls;
a second pair of pads, being attached onto an inner side of said second pair of sidewalls; and
a third pad, being attached onto an inner side of said top cover.

15. The pressure resistance cover for the display panel of a portable computer of claims 9 or 10, wherein said rectangular frame and said top cover are integrally formed by a mold injection.

16. The pressure resistance cover for the display panel of a portable computer of claims 11, 12, 13 or 14, wherein said rectangular frame, said first pair of sidewalls, said second pair of sidewalls and said top cover are integrally formed by a mold injection.
